(19) United States
(12) Patent Application Publication
(10) Pub. No.: US 2006/0100972 A1
(43) Pub. Date: May 11, 2006

(54) Automated software-based hardware tracking system

(75) Inventors: Joseph James Chianese, Brookfield, WI (US); William Peterson, Sussex, WI (US); Erik Peterson, Milwaukee, WI (US); Philip James Bylsma, Brookfield, WI (US)

Correspondence Address: ARTZ & ARTZ, P.C., 28333 TELEGRAPH RD., SUITE 250, SOUTHFIELD, MI, 48034, US

(73) Assignee: GE Medical Systems Technology LLC, Waukesha, WI (US)

(21) Appl. No.: 10/904,001

(22) Filed: Oct. 19, 2004

(51) Int. Cl. G06F 17/30

(52) U.S. Cl. 707/1

(57) ABSTRACT

A hardware tracking system includes memory storage devices on tracked parts containing unique serial numbers, part numbers, revision numbers, and firmware versions. At power up and after a reset, a host computer or real-time subsystem downloads this information and compares it to the information stored in a central database. Changes in data in a central database log file indicate a replacement or update of the component, which is then used to automatically update the database. Each change causes the generation of a new record having date and time information attached thereto. These records are scanned to determine the system evolution. They are also compared to an error log and diagnostic history information to generate a cause versus effect occurring during troubleshooting. The system also tracks and records the number of times a part is removed and re-inserted, indicating shot-gunning of the system by field engineers.

### TECHNICAL FIELD

The present invention relates generally to hardware tracking systems, and more particularly, to an automated software based hardware tracking system.

Determining the history of components replaced in a given system has been a long-standing issue for field engineers (FE) and service engineering in general. Field engineers require identification of previously replaced components when diagnosing long term intermittent problems. This is particularly true if multiple field engineers are working on the same system at different times. For service engineering organizations, the ability to track failures in the field is paramount to determining the mean time between failures (MTBF) of components.

Additionally, tracking component revisions is crucial for tracking a failure to a particular board. This information aids in determining how often a part failed in the field in order to determine if a component failure or a design problem exists. Presently, the FE relies on written records for failure history, which are sometimes neglected during intense troubleshooting sessions. The written records are not available to service engineers who may be trying to service the system remotely through a remote electronic connection.

Additionally, no system currently exists to poll the installed systems and obtain the configuration. Service personnel must physically inspect the system parts to determine the configuration of options. Marketing, engineering and manufacturing have no reliable method of tracking the hardware options installed across a segment of systems or even for a particular system to aid in decision making processes.

Additionally, tracking the location of part revisions across the large number of installed systems and variety of configurations is currently not maintained. Performing a recall of a specific board revision requires a physical visit to every site to determine the board revision by inspection just to determine if a specific part of a system needs to be recalled.

Service engineering relies heavily on dispatch information to determine how well systems are operating. This information is sometimes flawed due to the elapsed time between the service call and the closing of the dispatch. Another important aspect to engineering is the amount of shot gunning (i.e. random swapping of boards and other parts) that is occurring in the field. Currently, there is no way to track this expensive and time consuming troubleshooting procedure.

The disadvantages associated with current hardware tracking systems have made it apparent that a new technique for hardware tracking is needed. The new technique should track component revisions without relying on written records. The new technique should also track troubleshooting procedures. The present invention is directed to these ends.

### SUMMARY OF THE INVENTION

In accordance with one aspect of the invention, a host computer for a part tracking system includes a logger adapted to receive a first unit of configuration information from a memory storage device containing a unique number in a first part and generate a log file therefrom. The logger is further adapted to detect changes in the configuration information with reference to a content of a current status file within a central database. The host computer further includes a viewer to display this information via a service browser. The viewer also has the ability to add comments to the log file to enable the tracking of pertinent information. The parser is further adapted to return an error condition in response to a missing log file or a corrupt log file and generate an error condition message in response to the corrupt log file. The parser is still further adapted to parse the log file into a header and individual log messages.

In accordance with another aspect of the invention, a part tracking method includes detecting and downloading a first unit of configuration information from a memory device on a part. The first unit of configuration information is compared with a second unit of configuration information within a central database. The central database is automatically updated in response to a difference between the first unit of configuration information and the second unit of configuration information. The process of updating the database occurs automatically in the background when the possibility of a change in hardware configuration exists. In one instance, the configuration information is updated whenever the system is power cycled or booted.

Another aspect of the invention, collects the configuration information electronically from multiple installed systems and correlates the part information in a super-central database. The super-central database contains all configuration information for every system installed with the invention installed. This information aids marketing, manufacturing and engineering in decision making regarding the types of hardware options customers prefer.

Another aspect of the invention provides a method for inspecting the parts and part revisions of a given system remotely and electronically. This aids engineering and service during the recall of a faulty part.

One advantage of the present invention includes data mining and monitoring. In other words, information about board swap outs, replacements, configurations, and revision is readily available to engineering, providing crucial information that is stored in a centralized data warehouse (central database). This information is readily available to remote service engineers who may be trying to perform system fixes through an electronic remote connection.

Another advantage includes cost savings through tracking hardware replacements, thereby preventing replacement of the same board multiple times during system troubleshooting. Also, the system increases the likelihood that the correct (i.e. improperly functioning) board will be replaced, thereby saving time costs and part costs.

Another advantage includes tracking revisions of boards installed in various systems throughout the region through the super-central database. This provides access to part identification if the need for a part recall should occur. The costs of the recall can more readily be estimated from the quantities of the parts installed and the recall list can be created.

Other objects and advantages of the present invention will become apparent upon the following detailed description and appended claims, and upon reference to the accompanying drawings.

### BRIEF DESCRIPTION OF THE DRAWINGS

FIG. 1 is a block diagram of a hardware tracking system in accordance with one embodiment of the present invention;

FIG. 2 is a logic flow diagram of the logger operations of a hardware tracking system in accordance with another embodiment of the present invention; and

FIG. 3 is a logic flow diagram of the viewer and parser operations of a hardware tracking system in accordance with another aspect of the present invention.

### DETAILED DESCRIPTION OF THE PREFERRED EMBODIMENT

The present invention is illustrated with respect to a hardware tracking system 10, particularly suited for Magnetic Resonance machines. The present invention is, however, applicable to various other uses that may require hardware tracking, as will be understood by one skilled in the art.

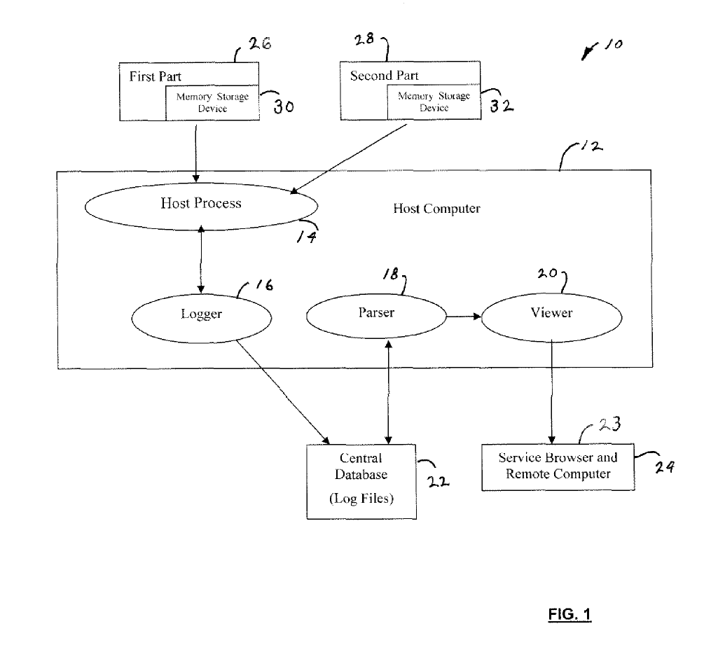

Referring to FIG. 1, a hardware tracking system 10, including a host computer 12, is illustrated. The host computer 12 includes a host process unit 14, a logger 16, a parser 18, and a viewer 20. Coupled to the host computer 12 are: a central database 22 and a service browser 24 and remote computer 23.

Generally, the host computer 12 or real-time subsystem downloads information from a plurality of parts 26, 28 having individual memory storage devices 30, 32 and compares this with information stored in the central database 22. A user accesses the information in the central database 22 through the viewer 20 and parser 18 from the service browser 24.

The host computer 12 downloads part information during, for example, power up and after reset. Information downloaded includes, but is not limited to, location, firmware revision, serial number, part number, and hardware revision. The host computer 12 includes a host process receiver 14 that downloads the aforementioned information. The logger 16 receives signals from the host process receiver 14 and generates a logger 16 signal therefrom to log the received information. The logger 16 automatically updates when new parts are added and when the part location is unique. The logger 16 signal is received in the central database 22. The parser 18 parses information in the central database 22 and generates a parser 18 signal for the individual pieces of information. The viewer 20 receives the parser 18 signals and generates viewer 20 signals, which are received in remote computers through service browsers 24.

The parts 26, 28, illustrated as a first part 26 and a second part 28, are representative of a plurality of parts that are tracked by the present invention. Each part 26, 28 includes a memory storage device 30, 32 including such programmed information as location, firmware revision, serial number, part number, and hardware revision information. The embodied parts 26, 28 are circuit boards included in Magnetic resonance systems (MR), however, the present invention is applicable to any system including interchangeable parts, as will be understood by one skilled in the art.

The central database 22 is embodied as a separate unit to the host computer 12; however, alternate embodiments include the central database 22 as a component of the host computer 12, as will be understood by one skilled in the art. The central database 22 receives the logger 16 signals and stores the log files contained therein. Each log file ideally includes date and time information for each part. The central database 22 shares information with the parser 18 and viewer 20 such that user input and comments can be added to each log file, as will be discussed later.

The service browser 24 and remote computer 23 is embodied as a typical computer downloading information through the World-Wide-Web from the viewer 20. The host computer 12 is accessible to the remote computer 23 via the web service browser 24 or by retrieving the database records via file transfers protocol (FTP) from storage in the central database 22.

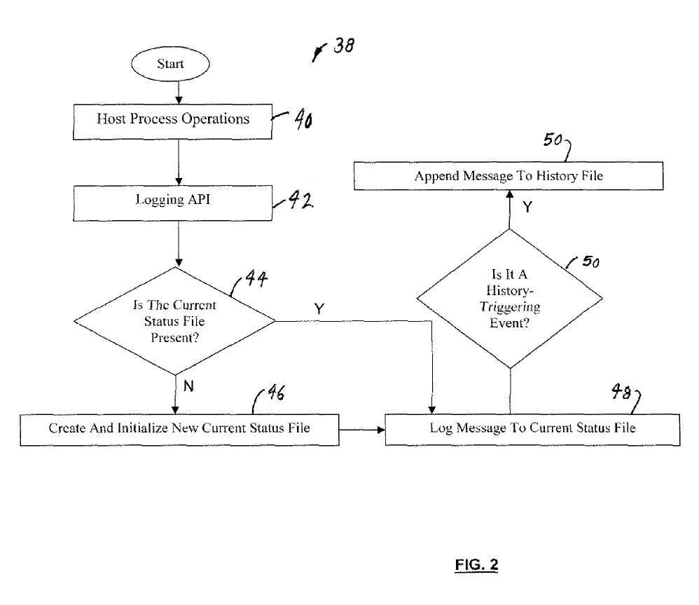

Referring to FIG. 2, a logic flow 38 diagram of the logger 16 operations of the hardware tracking system 10, in accordance with another embodiment of the present invention, is illustrated. Logic starts in operation block 40 when a host process sends a hardware change message to the host computer 12 for logging.

In operation block 42, one or more hardware specific software or host process 14 logs a message, and a logging Application Program Interface within the logger 16 activates. In other words, the logger receives a first unit of configuration information, such as a part serial number.

In inquiry block 44, a check is made whether the current status file is present. The current status file is the section of a log file in the central database 22 having current part information, whereas a history file is a section of a log file including part change history information. Either the current status file or the history file is a second unit of configuration information to which the first unit of configuration information is compared.

For a negative response, in operation block 46, when a log file is not present during message logging, e.g. the first time the logger 16 is called in a new remote computer 23; the logger 16 generates a new log file (either a current status file or a history file). The logger 16 then initializes the newly created log file by writing header information, and, in operation block 48, logs the message to the current status file. Otherwise, in operation block 48 the logger 16 logs the message to the current status file without generating a new current status file.

In inquiry block 50, the logger 16 detects changes to the hardware configuration with reference to the contents of the current status file and an inquiry is made whether the current event is a history triggering event. For a positive response, if there is any change in the hardware configuration, the logger 16 appends a new hardware change message to the history file in operation block 52. The logger 16 also provides a file locking mechanism to sync with the system 10, thereby preventing multiple processes writing to the same log file simultaneously.

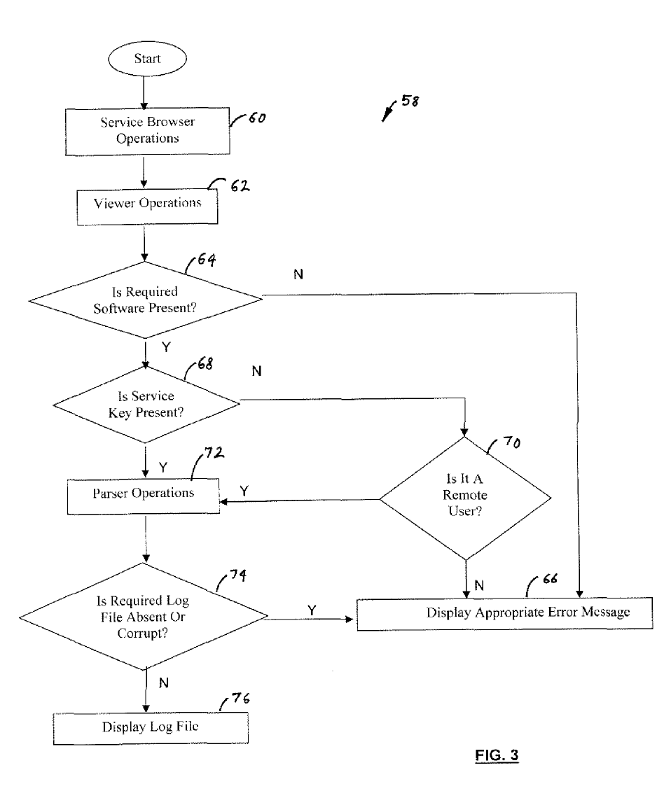

Referring to FIG. 3, a logic flow diagram 58 of viewer 20 and parser 18 operations of a hardware tracking system 10, in accordance with another aspect of the present invention, is illustrated. Logic starts in operation block 60 where a service browser 24 is used to gather information from the central database 22 or host computer 12. The viewer 20 is invoked through a component, e.g. a button, from the service browser 24.

In operation block 62, the viewer 20 is invoked through activation of component, e.g. a button, from the service browser 24. The viewer 20 displays an appropriate error message if the required log file is not present in the system 10.

In inquiry block 64, a check is made whether the required software is present. For a negative response, in operation block 66, the viewer 20 displays an appropriate error message if the required log file is found to be corrupt.

Otherwise, in inquiry block 68, a check is made whether the service key is present. For a negative response, a check is made in inquiry block 70 whether the user is a remote user from OCL. The viewer 20 provides the necessary searching capabilities based on, for example, board type and date range. The viewer 20 addends comments to specific entries through the service browser 24. For a negative response in operation block 66, the viewer 20 displays an appropriate error message.

For a positive response to either blocks 68 or 70, in operation block 72, parser 18 operations activate. In other words, when a user views a log file, the viewer 20 invokes the parser 18 routines to read the contents from the corresponding log file.

In inquiry block 74, a check is made whether the required log file is absent or corrupt. For a positive response in operation block 66, the parser 18 returns an appropriate error condition signal to the viewer 20 when a log file is not found or found to be corrupt. The parser 18 logs a message to the central database 22 if a log file is found to be corrupt. The log file is backed up and the logger 16 initializes a fresh log file. The parser 18 parses a log file into a header and individual log messages, which in turn will be used by the viewer 20. Otherwise, in operation block 76, the log file is displayed on the viewer 20 or the remote computer 24.

In operation block 66, the viewer 20 displays an appropriate error message if the required log file is not present in the system 10. The viewer 20 displays an appropriate error message if the required log file is found to be corrupt. The viewer 20 displays the contents of a log file if it is correctly parsed.

When a log file grows to a predetermined maximum size, a back-up file is generated. Any existing back-up is over-written. After the back-up for a log file is generated, a fresh log file is initiated. The log files are maintained in encrypted form in the system 10.

One example of a possible sequence for user interfacing includes: a user at a remote computer 23 connects to the host computer 12 through the service browser 24. The service browser 24 includes a user interface (UI), e.g. a button, to view the log files in a browser page. The service browser 24 displays the common service desktop of the host computer 12. The user chooses (e.g. presses the button) to view the error log files, and a current status log is displayed on a service browser window. The web server interface (service browser 24) executes the industry standard Common Gateway Interfaces (CGIs) and Hyper Text Markup Language (HTML) to display dynamic screens. Information is displayed on the remote computer 23 in two forms: present configuration and configuration history. Information is also displayed on any additional computer or remote server that supports a web browser (UNIX, Microsoft Windows, etc.). The system 10 handles an unlimited number of variations in configuration. Additional hardware is added or removed from the system 10 without requiring maintenance on the central database 22 or user interface.

Access to the central database 22 is via the world-wide-web (WWW), making the host computer 12 remotely accessible. Information is displayed in two forms. The first form is an HTML page containing the present configuration data. This information is used to determine what hardware is present and the revisions of hardware installed.

The second form of displayed information is a history HTML page. The history page contains one line for each change detected for any given part. Comments are added to each line giving a detailed record of why the replacement occurred and any miscellaneous information needed for future reference.

In operation, the system 10 requires that all tracked parts include a memory storage device 30, 32 containing a unique serial number, part number, revision number, and firmware version for the part. At power up and after a reset, the host computer 12 or real-time subsystem downloads this information and compares it to the information stored in a central database 22. Changes in data indicate a replacement or update of the part 26, 28, which is then used to automatically update the central database 22. Each change causes creation of a new record along with appended date and time information. These records are scanned to determine the evolution of the MR system and MR parts 26, 28. They are also compared with the error log and diagnostic history information to generate a cause and effect of what transpired during troubleshooting. This information is crucial in determining the number of false positives and negatives associated with a diagnostic MR test. In addition, the system 10 tracks the number of times a board or part 26, 28 is removed and re-inserted, indicating the field engineer is shot-gunning the MR system. This is automatically recorded to provide information on problem MR systems where this type of inefficient trouble-shooting is occurring.

While the invention has been described in connection with one or more embodiments, it should be understood that the invention is not limited to those embodiments. On the contrary, the invention is intended to cover all alternatives, modifications, and equivalents, as may be included within the spirit and scope of the appended claims.

What is claimed is:

1. A host computer for a part tracking system comprising:
a logger adapted to receive a first unit of configuration information from a memory storage device in a first part and generate a log file therefrom, said logger further adapted to detect changes in said first unit of configuration information with reference to a content of a current status file within a central database;
a viewer adapted to activate in response to a command from a service browser, said viewer adapted to display signals from said parser thereby generating a viewer signal, said viewer further adapted to add a first comment to said log file in response to a signal from a service browser; and
a parser adapted to read a content of said log file, said parser further adapted to return an error condition in response to a missing log file and a corrupt log file, said parser further adapted to generate an error condition message in response to said corrupt log file, said parser further adapted to parse said log file into a header and an individual log message signal.

2. The system of claim 1, wherein said first unit of configuration information comprises ant least one of: location, firmware revision, serial number, part number, and hardware revision information.

3. The system of claim 1, wherein said service browser executes CGIs to display at least one dynamic screen.

4. The system of claim 1 further comprising a remote computer adapted to receive said viewer signal.

5. The system of claim 4, wherein said viewer signal comprises:
configuration information and configuration history information.

6. The system of claim 1, wherein said logger is adapted to receive said first unit of configuration information following a host computer power-up or reset.

7. The system of claim 1, wherein said log file comprises date and time information for a part alteration.

8. A part tracking method comprising:
detecting a first unit of configuration information from a memory device on a part;
downloading said first unit of configuration information;
comparing said first unit of configuration information with a second unit of configuration information within a central database; and
automatically updating said central database in response to a difference between said first unit of configuration information and said second unit of configuration information.

9. The method of claim 8, wherein downloading said first unit of configuration information further comprises downloading said first unit of configuration information during a host computer power-up or a host computer reset.

10. The method of claim 8, wherein automatically updating said central database further comprises tracking a number of times said part is removed and reinserted.

11. The method of claim 8 further comprising displaying current configuration information and previous configuration information.

12. The method of claim 8, wherein automatically updating further comprises generating a new database record having date and time information.

13. The method of claim 8 further comprising generating an error condition signal message in response to a corrupt second unit of configuration information.

14. A part tracking method comprising:
detecting configuration information from a part;
downloading said configuration information;
comparing said configuration information with configuration information in a central database;
automatically updating said central database with said configuration information;
tracking a number of times said part is removed and reinserted;
generating a new database record including date and time information;
comparing said new database record to an error log and a diagnostic history; and
accessing said central database through a web service browser.

15. The method of claim 14, wherein downloading said configuration information further comprises downloading said configuration information during a host computer power-up or a host computer reset.

16. The system of claim 14 further comprising further comprising displaying current configuration information and previous configuration information.

17. The system of claim 14, wherein accessing said central database through said web service browser further comprises utilizing an HTML/CGI interface.

18. The method of claim 14 further comprising generating an error condition signal message in response to corrupt configuration information.

19. The system of claim 14, wherein tracking further comprises automatically recording said number of times said part is removed and reinserted.
